(19) United States
(12) Patent Application Publication
(10) Pub. No.: US 2007/0294880 A1
(43) Pub. Date: Dec. 27, 2007

(54) Method for making surface mount inductor

(75) Inventor: Ming Yen Hsieh, Taoyuan Hsien (TW)

Correspondence Address: CHARLES E. BAXLEY, ESQ., 90 JOHN STREET, THIRD FLOOR, NEW YORK, NY, 10038, US

(73) Assignee: Tai-Tech Advanced Electronics Co., Ltd.

(21) Appl. No.: 11/472,680

(22) Filed: Jun. 21, 2006

(51) Int. Cl. H01F 5/00

(52) U.S. Cl. 29/602.1; 336/200; 336/232

(57) ABSTRACT

A method may first mold a casing and a core of a surface mount inductor, a metal layer is then attached to the lower portion of each of two side panels of the core, conductor contacts are then electroplated onto the side panels of the core, and a wire may then be easily and quickly attached onto or wound around an opened horizontal part of the core with a winding machine for allowing the surface mount inductor to be easily and quickly manufactured. The wire includes a terminal secured to one of the conductor contact before the wire is wound around the horizontal part of the core, and another terminal secured to the other conductor contact after the wire has been wound around the horizontal part of the core.

### BACKGROUND OF THE INVENTION

1. Field of the Invention

The present invention relates to a surface mount inductor, and more particularly to a method for making a surface mount inductor which includes an improved structure having a suitable or decreased height for allowing the surface mount inductor to be easily and quickly manufactured.

2. Description of the Prior Art

Typical surface mount inductors comprise a drum-shaped core including a top flange, a bottom flange, and a central part interposed between the top and bottom flanges, and a wire wound around the central part of the drum-shaped core.

For example, U.S. Pat. No. 5,751,203 to Tsutsumi et al. discloses one of the typical surface mount inductors also comprising a wire wound around a central part of a drum-shaped core which includes a top flange disposed on top of the central part and a bottom flange disposed on the bottom portion of the central part, for allowing the central part to be interposed between the top and bottom flanges.

Normally, the typical surface mount inductors are required to be made as short as possible. However, the top and bottom flanges should include a suitable height or thickness such that the height or length of the central part will be limited, and such that the typical surface mount inductors may not be made to the required height.

U.S. Pat. No. 6,292,081 to Armfield et al. discloses another typical surface mount inductor comprising a core substantially toroidal in shape, and a wire wound around the toroidal core. However, the toroidal core is erected such that the typical surface mount inductors include a great height. In addition, the wire is required to be engaged into and out of the center hole of the toroidal core a number of times, such that the typical surface mount inductors may not be made in great speed.

U.S. Pat. No. 7,042,324 to Watanabe discloses a further typical surface mount inductor also comprising a drum-shaped core including a central part, a top flange disposed on top of the central part, a bottom flange disposed on the bottom portion of the central part, and a wire wound around the central part of the drum-shaped core. However, similarly, the top and bottom flanges should include a suitable height or thickness such that the height or length of the central part will be limited, and such that the typical surface mount inductors may not be made to the required height.

It is to be noted that, in the typical surface mount inductors, the wire may not be easily and quickly wound around or onto the central part of the core with winding machines, and should be wound around or onto the central part of the core manually by the workers.

The present invention has arisen to mitigate and/or obviate the afore-described disadvantages of the conventional surface mount inductors manufacturing methods.

### SUMMARY OF THE INVENTION

The primary objective of the present invention is to provide a method for making a surface mount inductor which includes an improved structure having a suitable or decreased height for allowing the surface mount inductor to be easily and quickly manufactured.

In accordance with one aspect of the invention, there is provided a method for manufacturing a surface mount inductor comprising a core including two side panels each having a conductor contact attached to a lower portion thereof, and including a central part coupled between the side panels, a wire to be wound around the central part of the core and including two terminals coupled to the conductor contacts of the core respectively, and a casing including a chamber defined between a front plate and a rear plate and an upper plate for receiving the core, the method comprising molding the casing and the core, attaching a metal layer to the lower portion of each of the side panels of the core, electroplating the conductor contacts onto the lower portions of the side panels of the core respectively, winding the wire around the horizontal part of the core, and engaging the core into the chamber of the casing and securing the core to the casing. The opened structure of the horizontal part of the core allows the wire to be easily and quickly attached onto or wound around the horizontal part of the core with a winding machine.

The core may be adhered to the casing. The wire includes a first terminal secured to the conductor contact of one of the side panels of the core before the wire is wound around the horizontal part of the core, and includes a second terminal secured to the conductor contact of the other side panel of the core after the wire is wound around the horizontal part of the core.

The metal layer is made of silver powder and heated and secured to the lower portions of the side panels of the core. The casing and the core may preferably be molded from particles.

The particles are dried before molding the casing and the core, and are preferably formed from powder materials. The powder materials are mixed with a binder material to form the particles. The powder materials and the binder material are heated before forming the particles.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a surface mount inductor to be made with a method in accordance with the present invention; and

FIG. 2 is a partial exploded view of the surface mount inductor. illustrating the other arrangement of the surface mount inductor; and

FIG. 3 is a flow chart illustrating the manufacturing processes for making the surface mount inductor.

### DETAILED DESCRIPTION OF THE PREFERRED EMBODIMENT

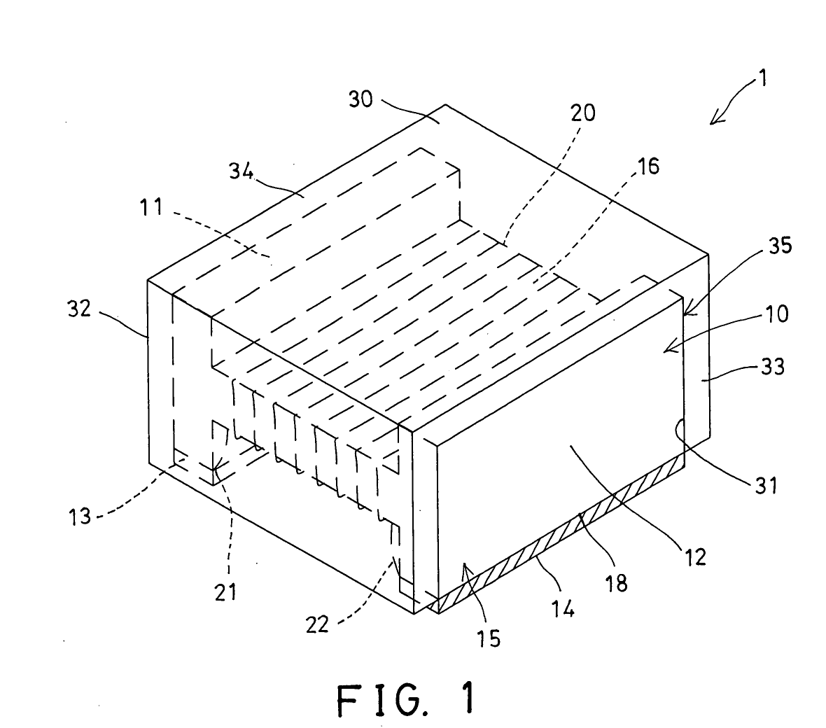

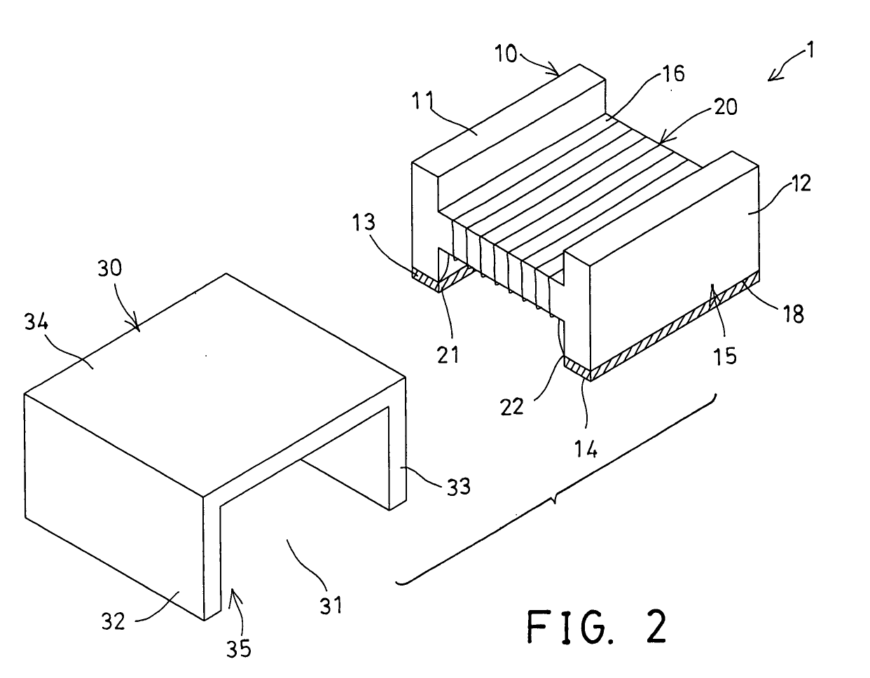

Referring to the drawings, and initially to FIGS. 1 and 2, a surface mount inductor 1 to be made with a method in accordance with the present invention comprises a substantially H-shaped core 10 made of ferrite materials, ceramic materials or the like, and formed by such as molding or mold-injection processes, and including two vertical or erected side panels 11, 12 each having a conductor contact or welding material or member 13, 14 attached or secured to the lower or bottom portion 15 thereof for electrically coupling or securing to various electric circuit boards (not shown) or the like, and including a horizontal or central part 16 horizontally coupled between the side panels 11, 12 for forming the H-shaped core 10.

A wire 20 is to be wound around the horizontal part 16 of the core 10 and includes two ends or terminals 21, 22 coupled to the conductor contacts or welding materials or members 13, 14 of the core 10 respectively for electrically coupling to the electric circuit boards via the conductor contacts or welding materials or members 13, 14 of the core 10. A casing 30 includes a chamber 31 formed therein and defined between a front plate 32 and a rear plate 33 and an upper plate 34 for receiving the core 10 and for forming the surface mount inductor 1. The casing 30 may also be made of ferrite materials, ceramic materials or the like, and may also be formed by such as molding or mold-injection processes or the like.

It is preferable that the front plate 32 and the rear plate 33 of the casing 30 are disposed or arranged or positioned on the front and the rear portions of the core 10, and/or the side panels 11, 12 and the horizontal part 16 of the core 10 are disposed or arranged or positioned between the front plate 32 and the rear plate 33 of the casing 30, and/or the side panels 11, 12 of the core 10 are disposed or arranged or positioned on the two open side portions 35 of the casing 30 and preferably engaged with the front plate 32 and the rear plate 33 of the casing 30 for enclosing the chamber 31 and/or the two open side portions 35 of the casing 30, and thus for suitably receiving the coiled wire 20 within the chamber 31 that is now defined between the front plate 32 and the rear plate 33 of the casing 30 and the side panels 11, 12 of the core 10.

It is to be noted that the upper plate 34 of the casing 30 and the horizontal part 16 of the core 10 may include a suitable height or thickness such that the height of the present surface mount inductor may be made to the required or decreased height. Furthermore, the horizontal part 16 of the core 10 is opened such that the wire 20 may be easily and quickly engaged or wound onto and around the horizontal part 16 of the core 10 with various automatic machines or facilities (not shown). The above-described structure for the surface mount inductor 1 has been filed in a co-pending patent application and will be provided for the reference for the method of the present invention for easily and quickly manufacturing the surface mount inductor 1.

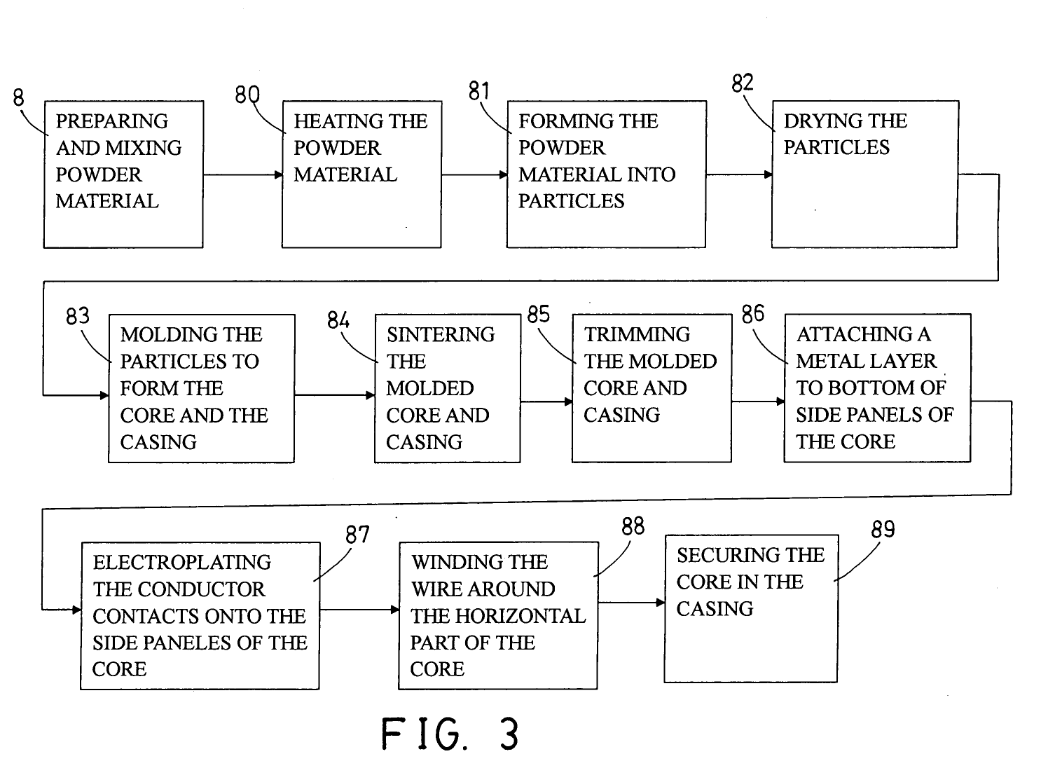

In manufacturing the surface mount inductor 1, a powder material of ferrite materials, ceramic materials or the like is first provided or prepared by the user or worker and suitably mixed together with such as a typical vibrator machine (not shown) in a process 8 as shown in FIG. 3, the powder material is then received in a container (not shown) and heated in a process 80 in such as an oven to a temperature ranging from 850-950° C., and keep for about 2-3 hours, in order to remove contaminants from the powder material, and for preliminarily crystallizing the powder material.

In a process 81, the powder material is then filled into a typical stirring machine (not shown), and a resin or binder material and an agent, such as a dispersing agent are also filled into the stirring machine for allowing the binder material and the agent to be applied or attached onto the powder material and to form particles. The particles are then dried in a process 82, with such as typical drying machines (not shown) for about 5-10 minutes and with a temperature ranging from 170-190° C., in order to dehydrate the particles. It is preferable that the particles are sieved with such as typical sieving machines (not shown) to form or to collect or to select the particles having a diameter of about 150 μm.

The particles are then molded or hot-pressed together in a process 83, to form the molded casing 30 and the molded core 10, which are then heated or sintered in such as a typical sintering oven (not shown) in a process 84 to a temperature ranging from 1000-1100° C., and keep for about 3-4 hours, in order to form the molded casing 30 and the molded core 10, and to crystallize the ferrite or ceramic material. The molded casing 30 and the molded core 10 are then trimmed or ground or polished in a process 85 to remove burrs and to form a smooth outer appearance to the molded casing 30 and the molded core 10.

In a following process 86, a metal layer 18 (FIGS. 1, 2) made of such as silver powder is then applied onto the lower or bottom portion 15 of each of the side panels 11, 12 of the core 10, and heated or sintered or attached or secured onto the side panels 11, 12 of the core 10 in such as an oven to a temperature ranging from 610-650° C., and keep for about 5-10 minutes. The core 10 is then disposed in a typical electroplating bath (not shown) in a process 87 for applying or electroplating the conductor contacts or welding materials or members 13, 14 onto the metal layers 18 and/or onto the lower or bottom portions 15 of the side panels 11, 12 of the core 10 respectively.

In a following process 88, one of the two ends or terminals 21 of the wire 20 is first secured or welded to the conductor contact 13 of the side panel 11 of the core 10, and the wire 20 is then wound around the horizontal part 16 of the core 10 with such as a winding machines (not shown), and the other end or terminal 22 of the wire 20 is then secured or welded to the conductor contact 13 of the other side panel 12 of the core 10, to allow the wire 20 to be easily and quickly wound around the horizontal part 16 of the core 10 with the winding machines.

In a following process 89, the core 10 thus formed and having the wire 20 wound thereon is then disposed or positioned or engaged into the chamber 31 of the casing 30, and secured to the casing 30 with such as an adhesive material, for allowing the horizontal part 16 of the core 10 and the coiled wire 20 to be suitably received and contained within the chamber 31 that is defined between the front plate 32 and the rear plate 33 of the casing 30 and the side panels 11, 12 of the core 10.

It is to be noted that the molded casing 30 and the molded core 10 may be directly formed or provided, and then the metal layer 18 of such as silver powder may then be directly applied onto the lower or bottom portion 15 of each of the side panels 11, 12 of the core 10 in the process 86, for allowing the conductor contacts or welding materials or members 13, 14 to be applied or electroplated onto the lower or bottom portions 15 of the side panels 11, 12 of the core 10 respectively in the process 87, and then for allowing the wire 20 to be easily and quickly wound around the horizontal part 16 of the core 10 with the winding machines.

Accordingly, the surface mount inductor in accordance with the present invention includes an improved structure having a suitable or decreased height, and for allowing the surface mount inductor to be easily and quickly manufactured.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for manufacturing a surface mount inductor comprising a core including two side panels each having a conductor contact attached to a lower portion thereof, and including a central part coupled between said side panels, a wire to be wound around said central part of said core and including two terminals coupled to said conductor contacts of said core respectively, and a casing including a chamber defined between a front plate and a rear plate and an upper plate for receiving said core, said method comprising:
molding said casing and said core,
attaching a metal layer to said lower portion of each of said side panels of said core,
electroplating said conductor contacts onto said lower portions of said side panels of said core respectively,
winding said wire around said horizontal part of said core, and
engaging said core into said chamber of said casing and securing said core to said casing.

2. The surface mount inductor as claimed in claim 1, wherein said core is adhered to said casing.

3. The surface mount inductor as claimed in claim 1, wherein said wire includes a first terminal secured to said conductor contact of one of said side panels of said core before said wire is wound around said horizontal part of said core, and includes a second terminal secured to said conductor contact of the other side panel of said core after said wire is wound around said horizontal part of said core.

4. The surface mount inductor as claimed in claim 1, wherein said metal layer is made of silver powder and heated and secured to said lower portions of said side panels of said core.

5. The surface mount inductor as claimed in claim 1, wherein said casing and said core are molded from particles.

6. The surface mount inductor as claimed in claim 5, wherein said particles are dried before molding said casing and said core.

7. The surface mount inductor as claimed in claim 5, wherein said particles are formed from powder materials.

8. The surface mount inductor as claimed in claim 7, wherein said powder materials are mixed with a binder material to form said particles.

9. The surface mount inductor as claimed in claim 8, wherein said powder materials and said binder material are heated before forming said particles.
